(19) United States
(12) Patent Application Publication
(10) Pub. No.: US 2023/0258400 A1
(43) Pub. Date: Aug. 17, 2023

(54) Systems and Methods for Utilizing Boil-Off Gas for Supplemental Cooling in Natural Gas Liquefaction Plants

(71) Applicant: Bechtel Energy Technologies & Solutions, Inc., Houston, TX (US)

(72) Inventors: Matt Taher, Sugar Land, TX (US); Cyrus B. Meher-Homji, Richmond, TX (US); Pradeep Pillai, Houston, TX (US)

(73) Assignee: Bechtel Energy Technologies & Solutions, Inc., Houston, TX (US)

(21) Appl. No.: 18/016,176

(22) PCT Filed: Jul. 23, 2020
(86) PCT No.: PCT/US20/43311

§ 371 Date: Jan. 13, 2023

(51) Int. Cl. F25J 1/00; F25J 1/02; F17C 13/00

(52) U.S. Cl. CPC F25J 1/004; F25J 1/0022; F25J 1/0283; F25J 1/0236; F25J 1/0297; F25J 1/0267; F17C 13/00; F25J 2245/90; F25J 2230/60; F25J 2230/04; F17C 2265/034; F17C 2227/0157; F17C 2227/0323; F17C 2265/066; F17C 2227/0135; F17C 2221/033; F17C 2227/0388

(57) ABSTRACT

Systems and methods for using a multi-stage compressor to increase the temperature and pressure of BOG sent to a heat exchanger for cooling a separate liquid refrigerant. The subsequent stage(s) of the multi-stage compressor further compress the BOG, which is then recycled to a liquefaction unit or used as fuel gas for one or more turbines.

### CROSS-REFERENCE TO RELATED APPLICATIONS

None.

### FIELD OF THE DISCLOSURE

The present disclosure generally relates to systems and methods for using the boil-off gas (BOG) that is continuously generated in natural gas liquefaction plants for supplemental cooling. More particularly, the present disclosure relates to using a multi-stage compressor to increase the temperature and pressure of the BOG sent to a heat exchanger for cooling a separate liquid refrigerant. The subsequent stage(s) of the multi-stage compressor further compress the BOG, which is then recycled to a liquefaction unit or used as fuel gas for one or more turbines.

### BACKGROUND

Natural gas liquefaction plants store liquefied natural gas (LNG), which is primarily methane, in large cryogenic tanks that operate close to the boiling point of methane (−260° F.) at pressures slightly higher than atmospheric. These LNG tanks continuously generate BOG and use BOG compressors to maintain and control pressure in the LNG tanks. Conventional use of BOG is limited and does not contemplate practical applications for cooling a separate refrigerant that can be used for many applications such as pre-cooling the LNG feed gas, sub-cooling a single or mixed refrigerant employed in the process of LNG liquefaction, cooling hydrocarbon streams in a natural gas liquid (NGL) or heavy's removal unit, cooling gas turbine inlet air, cooling the totally enclosed air in a totally enclosed water-to-air-cooled electrical motor, cooling the enclosure/cabinet of a variable frequency drive (VFD) system, after cooling or inter-stage cooling of a single or multi-stage compressor, or comfort cooling.

### BRIEF DESCRIPTION OF THE DRAWING

The present disclosure is described below with references to the accompanying drawing, and in which:

FIG. 1 is a schematic diagram illustrating one embodiment of a system for utilizing BOG for supplemental cooling.

### DETAILED DESCRIPTION OF THE ILLUSTRATIVE EMBODIMENT

The subject matter of the present disclosure is described with specificity, however, the description itself is not intended to limit the scope of the disclosure. The subject matter thus might also be embodied in other ways, to include different structures, steps and/or combinations similar to and/or fewer than those described herein, in conjunction with other present or future technologies. Although the term “step” may be used herein to describe different elements of methods employed, the term should not be interpreted as implying any particular order among or between various steps herein disclosed unless otherwise expressly limited by the description to a particular order. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented. All streams described are carried by physical lines. To the extent that temperatures and pressures are referenced in the following description, those conditions are merely illustrative and are not meant to limit the disclosure.

The present disclosure overcomes one or more deficiencies in the prior art by using a multi-stage compressor to increase the temperature and pressure of the BOG sent to a heat exchanger for cooling a separate liquid refrigerant. In this manner, the chilled refrigerant can be used in a variety of cooling applications.

In one embodiment, the present disclosure includes a system for using a boil-off gas (BOG) to cool a separate refrigerant, comprising: i) a tank that contains the BOG; ii) a multi-stage compressor in fluid communication with the BOG and positioned downstream from the tank; and iii) a heat exchanger positioned between two stages of the multi-stage compressor and enclosing a portion of the separate refrigerant and a portion of the BOG for cooling the separate refrigerant, wherein the BOG exiting a last stage of the multi-stage compressor is connected to only one of a liquefaction unit and a turbine.

In another embodiment, the present disclosure includes a method for using a BOG to cool a separate refrigerant, comprising: i) directing the BOG from a tank to a multi-stage compressor; ii) compressing the BOG in an initial stage of the multi-stage compressor to increase a temperature of the BOG representing a compressed BOG with a temperature of about −30° F. to 20° F.; and iii) directing the compressed BOG to a heat exchanger wherein it is converted to a warmed BOG and cools a separate liquid refrigerant, the liquid refrigerant having a freezing temperature that is below a temperature of the compressed BOG in the heat exchanger.

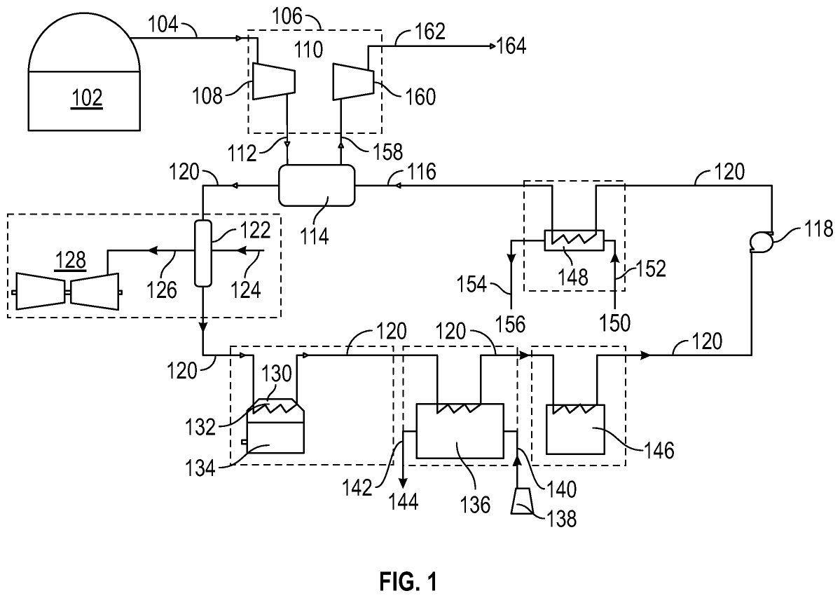

Referring now to FIG. 1, the system 100 utilizes BOG for supplemental cooling in a natural gas liquefaction plant. The LNG tank 102 will continuously generate BOG 104 to control pressure of the LNG tank 102. The LNG tank 102 may be greater than about 90% methane, which will operate at approximately −260° F. with a slightly higher pressure than atmospheric.

The BOG 104 is conveyed to a multi-stage compressor 106, which uses at least one initial stage compressor 108 to increase the temperature of the BOG 104 to an appropriate intermediate temperature range, which may be about −30° F. to 20° F. when the separate liquid refrigerant 116 is a glycol-water mixture. However, any other substitute may be used as the separate liquid refrigerant 116 instead of a glycol-water mixture.

A compressed BOG 112 is then conveyed to a heat exchanger 114 to cool a separate liquid refrigerant 116, wherein the refrigerant 116 has a freezing temperature that is below the temperature of the compressed BOG 112 in the heat exchanger. Heat transfer is achieved in the heat exchanger 114 because the operating temperature of the refrigerant 116 in the heat exchanger 114 is greater than the operating temperature of the compressed BOG 112 in the heat exchanger 114. The warmed BOG 158 is conveyed to at least one subsequent stage compressor 160 for further compression to produce a compressed BOG stream 162 that is recycled to a liquefaction unit or used as fuel gas for one or more turbines.

Chilled refrigerant 120 exits the heat exchanger 114 and can be used in a variety of cooling applications. At least one pump 118 may be used to convey the chilled refrigerant 120 through a closed loop cooling system to the various applications before returning to the heat exchanger 114 as the refrigerant 116 at a higher temperature than the chilled refrigerant 120.

In one application, the refrigerant 120 may be conveyed through the closed loop cooling system to a turbine air heat exchanger 122. Warm turbine inlet air 124 is cooled in the turbine heat exchanger 122 by the refrigerant 120. Cooled turbine inlet air 126 enters a gas turbine 128, which allows it to operate more efficiently.

In another application, the refrigerant 120 may be conveyed through the closed loop cooling system to an enclosed heat exchanger 130, which contains air 132 in a totally enclosed water-to-air cooled electrical motor 134, thus providing cool air for the motor.

In yet another application, the refrigerant 120 may be conveyed through the closed loop cooling system to a compressor heat exchanger 136, which encloses a portion of an outlet 140 from a compressor 138 (or of a stage of a compressor). The compressor outlet 140 is cooled in the compressor heat exchanger 136 and the cooled compressor outlet 142 is conveyed to a subsequent compressor stage in a multi-stage compressor or to the post compression application 144 if the compressor heat exchanger 136 is an aftercooler for the compressor outlet.

In yet another application, the refrigerant 120 may be conveyed through the closed loop cooling system to the comfort cooling system 146 of one or more buildings or fully/partially enclosed spaces to enhance comfort cooling.

In yet another application, the refrigerant 120 may be conveyed through the closed loop cooling system to a feed gas precooler 148, which encloses a portion of an LNG feed gas 152 from a feed source 150 that is precooled in the feed gas precooler 148. A precooled feed gas 154 is then conveyed to one or more LNG liquefaction units 156.

In certain embodiments, use of more than one application, and perhaps all applications, may be possible.

By placing the heat exchanger 114 at an intermediate position between two stages of the multi-stage compressor 106, the compressed BOG may be uniquely utilized for cooling the separate liquid refrigerant 120.

While the present disclosure has been described in connection with presently preferred embodiments, it will be understood by those skilled in the art that it is not intended to limit the disclosure to those embodiments. For example, the present disclosure has been described with respect to natural gas liquefaction plants, however, it is not limited thereto and may also be applied to other facilities (e.g. ethylene plants) to achieve similar results. It is therefore, contemplated that various alternative embodiments and modifications may be made to the disclosed embodiments without departing from the spirit and scope of the disclosure defined by the appended claims and equivalents thereof.

1. A system for using a boil-off gas (BOG) to cool a separate refrigerant, comprising:
a tank that contains the BOG;
a multi-stage compressor in fluid communication with the BOG and positioned downstream from the tank; and
a heat exchanger positioned between two stages of the multi-stage compressor and enclosing a portion of the separate refrigerant and a portion of the BOG for cooling the separate refrigerant, wherein the separate refrigerant is a glycol-water mixture, the BOG exiting an initial stage of the multi-stage compressor is compressed to a temperature of about −30° F. to 20° F. and the BOG exiting a last stage of the multi-stage compressor is connected to only one of a liquefaction unit and a turbine.

2. The system of claim 1, wherein the separate refrigerant is contained within a closed loop cooling system.

3. The system of claim 2, further comprising a turbine heat exchanger enclosing a portion of the closed loop cooling system for cooling inlet air connected to a gas turbine.

4. The system of claim 2, further comprising an electrical motor with an internal heat exchanger enclosing a portion of the closed loop cooling system for cooling the electrical motor.

5. The system of claim 2, further comprising a compressor heat exchanger enclosing a portion of a compressor outlet stream and a portion of the closed loop cooling system for cooling the compressor outlet stream.

6. The system of claim 2, further comprising a building enclosing a portion of the closed loop cooling system for comfort cooling.

7. The system of claim 2, further comprising a feed gas pre-cooler enclosing a portion of a feed gas and a portion of the closed loop cooling system for cooling the feed gas.

8. (canceled)

9. A method for using a BOG to cool a separate refrigerant, comprising:
directing the BOG from a tank to a multi-stage compressor;
compressing the BOG in an initial stage of the multi-stage compressor to increase a temperature of the BOG representing a compressed BOG with a temperature of about −30° F. to 20° F.; and
directing the compressed BOG to a heat exchanger wherein it is converted to a warmed BOG and cools the separate refrigerant, wherein the separate refrigerant is a glycol-water mixture having a freezing temperature that is below a temperature of the compressed BOG in the heat exchanger.

10. (canceled)

11. The method of claim 9, wherein the BOG is greater than about 90% methane.

12. The method of claim 9, further comprising pumping the liquid refrigerant through a closed loop cooling system for supplemental cooling.

13. The method of claim 9, further comprising directing the warmed BOG to at least one subsequent stage compressor for further compression to produce a compressed BOG stream that is recycled to a liquefaction unit or used as fuel gas for one or more turbines.
